(19) United States
(12) Patent Application Publication
(10) Pub. No.: US 2011/0069775 A1
(43) Pub. Date: Mar. 24, 2011

(54) SIGNAL PROCESSING METHOD AND APPARATUS FOR MIMO SYSTEM

(75) Inventors: Cheng Hsuan WU, Hsinchu (TW); Yen Chin LIAO, Hsinchu (TW); Yung Szu TU, Hsinchu (TW)

(73) Assignee: RALINK TECHNOLOGY CORPORATION, HSINCHU (TW)

(21) Appl. No.: 12/727,528

(22) Filed: Mar. 19, 2010

Related U.S. Application Data
(60) Provisional application No. 61/244,085, filed on Sep. 21, 2009.
(60) Provisional application No. 61/244,448, filed on Sep. 22, 2009.

(51) Int. Cl. H04B 7/02

(52) U.S. Cl. 375/267

(57) ABSTRACT

A signal processing method for a MIMO system comprises the steps of: arranging a plurality of frequency domain MIMO data streams into a plurality of groups, wherein each group comprises at least a frequency domain MIMO data stream; partitioning sub-carriers of each of the plurality of frequency domain MIMO data streams into a plurality of sub-channels; performing phase rotation for the plurality of frequency domain MIMO data streams, wherein the phases of the sub-carriers in a sub-channel are rotated the same amount, and different phase rotations are performed on different groups of the plurality of frequency domain MIMO data streams; transforming the plurality of frequency domain MIMO data streams into a plurality of time domain MIMO data streams; and performing CSD for the plurality of time domain MIMO data streams if each group comprises more than one frequency domain MIMO data stream, wherein the amount of CSD is different for each time domain MIMO data stream in a group.

### CROSS-REFERENCE TO RELATED APPLICATIONS

This application is an application under 35 USC 111(a) and claims priority under 35 USC 119 from Provisional Application Ser. No. 61/244,085 filed Sep. 21, 2009 and Provisional Application Ser. No. 61/244,448 filed Sep. 22, 2009 under 35 USC 111(b), the disclosures of which are incorporated herein by reference.

### BACKGROUND OF THE INVENTION

1. Field of the Invention

The present invention relates to a wireless system, and more particularly, to a multiple-input-multiple-output (MIMO) wireless system.

2. Description of the Related Art

In a multiple transmit antenna communication system, such as a MIMO system, a plurality of transmitting streams are transmitted with multiple antennas and received by multiple antennas to achieve spatial diversity effect. However, if the number of the transmitting spatial streams is less than the number of the transmitting antennas, two or more transmitting antennas may transmit highly correlated transmitting streams and cause an unintentional beam forming effect as shown in FIG. 1. As shown in FIG. 1, the system comprises two inverse fast Fourier transform (IFFT) modules to transform frequency domain MIMO data streams into time domain MIMO data streams. An unintentional beam forming effect is generated when two antennas transmit highly correlated transmitting streams. The unintentional beam forming effect helps the receivers in the direction of the formed beams to receive signals more easily. However, for other receivers, it becomes more difficult to receive signals transmitted by the transmitter. Therefore, the broadcast transmission quality may be degraded due to this unintentional beam forming effect.

To overcome the unintentional beam forming effect, a conventional method is to use the cyclic shift delay (CSD) technique to de-correlate the transmitted streams, such as in the system shown in FIG. 2, wherein CSD technique is performed after the IFFT computation. For example, in a four transmitting antenna system complying with IEEE 802.11n standard with 20M/40 MHz bandwidth, the CSD is performed in the time domain to avoid the unintentional beam forming effect. Moreover, CSD technique can also be performed before the IFFT computation, such as in the system shown in FIG. 3, which means that the CSD is performed in the frequency domain and the streams might have to rotate a certain angle. However, the amount of the CSD may influence the performance of the packet detection and the gain control performance. In IEEE 802.11n standard with 20M/40 MHz bandwidth, which applies four transmitting antennas, the CSD is confined between −200 ns and 0 to get a compromised performance in packet detection and gain control, wherein the cyclic shifts are multiples of 50 ns, which is exactly the sampling interval of the system fundamental sampling rate, i.e. 20 MHz.

However, as the number of applied antennas increases, or the transmission bandwidth is extended, the current method to overcome the unintentional beam forming effect is no longer applicable. Therefore, there is a need to design a method or system to solve the unintentional beam forming effect when a more complicated MIMO system is applied.

### SUMMARY OF THE INVENTION

It is therefore an objective of the present invention to provide an architecture and process of the CSD for a wireless system with more than four antennas.

It is therefore another objective of the present invention to provide an architecture and process of the CSD for a wireless system with more than four antennas system and support 20/40/80 MHZ bandwidths.

The signal processing method for a MIMO system according to one embodiment of the present invention comprises the steps of: arranging a plurality of frequency domain MIMO data streams into a plurality of groups, wherein each group comprises at least a frequency domain MIMO data stream; partitioning sub-carriers of each of the plurality of frequency domain MIMO data streams into a plurality of sub-channels; performing phase rotation for the plurality of frequency domain MIMO data streams, wherein the phases of the sub-carriers in each sub-channel are rotated by the same amount, and different phase rotations are employed on different groups of the plurality of frequency domain MIMO data streams; transforming the plurality of frequency domain MIMO data streams into a plurality of time domain MIMO data streams; and performing CSD for the plurality of time domain MIMO data streams if each group comprises more than one time domain MIMO data stream, wherein the amount of the CSD is different for each time domain MIMO data stream in a group.

The signal processing method for a MIMO system according to another embodiment of the present invention comprises the steps of: arranging a plurality of frequency domain MIMO data streams into a plurality of groups, wherein each group comprises at least one frequency domain MIMO data stream; partitioning sub-carriers of each of the plurality of frequency domain MIMO data streams into a plurality of sub-channels; performing phase rotation on the plurality of frequency domain MIMO data streams, wherein the phases of the sub-carriers in a sub-channel are rotated with the same amount, and different phase rotations are performed on different groups of the plurality of frequency domain MIMO data streams; performing cyclic shift delay on the plurality of frequency domain MIMO data streams if each group comprises more than one frequency domain MIMO data streams, wherein the amount of the cyclic shift delay is different for each frequency domain MIMO data stream in a group; and transforming the plurality of frequency domain MIMO data streams into a plurality of time domain MIMO data streams.

The signal processing method for a MIMO system according to another embodiment of the present invention comprises the steps of: extending at least one frequency domain MIMO data stream by padding zeroes at the beginning and the end of each of the at least one frequency domain MIMO data stream; transforming the at least one frequency domain MIMO stream into at least one time domain MIMO data stream; and performing CSD for the at least one time domain MIMO data stream to produce a plurality of time domain MIMO data streams, wherein the amount of the CSD is different for each of the time domain MIMO data streams.

The signal processing method for a MIMO system according to yet another embodiment of the present invention comprises the steps of: performing cyclic shift delay for at least one frequency domain MIMO data stream to produce a plurality of frequency domain MIMO data streams, wherein the amount of the cyclic shift delay is different for each of the frequency domain MIMO data streams; and transforming the plurality of frequency domain MIMO stream into a plurality of time domain MIMO data stream.

The signal processing apparatus for a MIMO system according to one embodiment of the present invention comprises a phase rotation module, an inverse Fourier transform module and a CSD module. The phase rotation module is configured to rotate the phases of the sub-carriers of a frequency domain MIMO data stream, wherein the sub-carriers of the frequency domain MIMO data stream are partitioned into a plurality of sub-channels, and the phases of the sub-carriers in the same sub-channel are rotated the same amount. The inverse Fourier transform module is configured to transform the frequency domain MIMO data stream into a time domain MIMO data stream. The CSD module is configured to perform CSD for the time domain MIMO data stream.

The signal processing apparatus for a MIMO system according to another embodiment of the present invention comprises a phase rotation and cyclic shift delay module and an inverse Fourier transform module. The phase rotation and cyclic shift delay module is configured to rotate the phases of the sub-carriers of a frequency domain MIMO data stream and perform cyclic shift delay for the frequency domain MIMO data stream, wherein the sub-carriers of the frequency domain MIMO data stream are partitioned into a plurality of sub-channels, and the phases of the sub-carriers in a sub-channel are rotated the same amount. The inverse Fourier transform module is configured to transform the frequency domain MIMO data stream into a time domain MIMO data stream.

The signal processing apparatus for a MIMO system according to another embodiment of the present invention comprises a zero padding module, an inverse Fourier transform module and a CSD module. The zero padding module is configured to extend a frequency domain MIMO data stream by padding zeroes at the beginning and end of the frequency domain MIMO data stream. The inverse Fourier transform module is configured to transform the frequency domain MIMO data stream into a time domain MIMO data stream. The CSD module is configured to perform CSD for the time domain MIMO data stream.

The signal processing apparatus for a MIMO system according to yet another embodiment of the present invention comprises a CSD module and an inverse Fourier transform module. The CSD module is configured to perform CSD for a frequency domain MIMO data stream. The inverse Fourier transform module is configured to transform the frequency domain MIMO data stream into a time domain MIMO data stream.

### BRIEF DESCRIPTION OF THE DRAWINGS

The objectives and advantages of the present invention will become apparent upon reading the following description and upon referring to the accompanying drawings of which:

FIG. 1 shows an example of an unintentional beam forming;

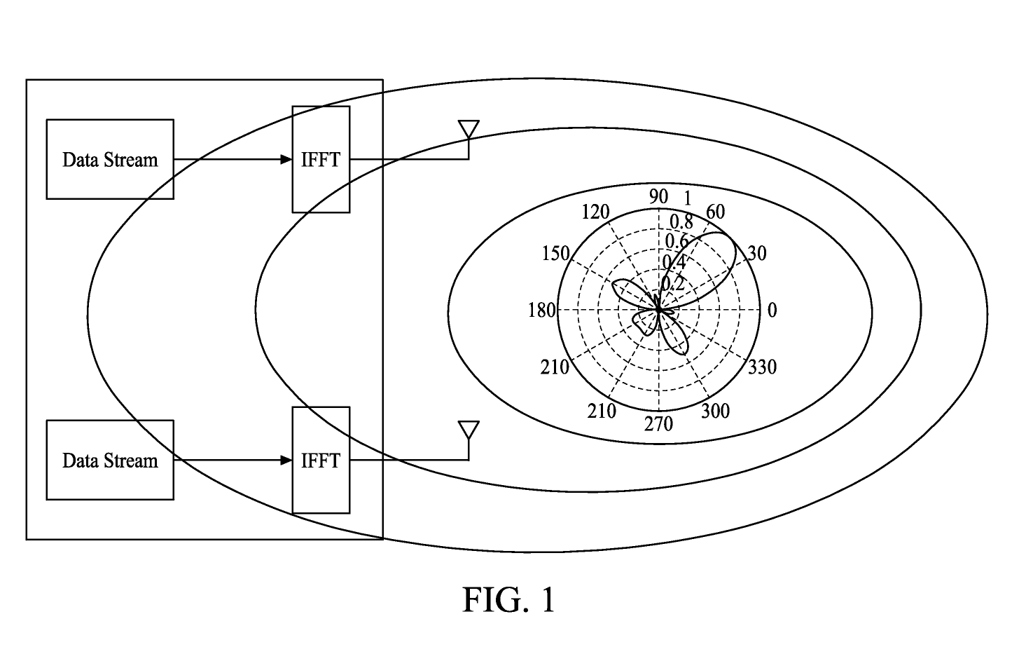

FIG. 2 shows a MIMO system using CSD technique;

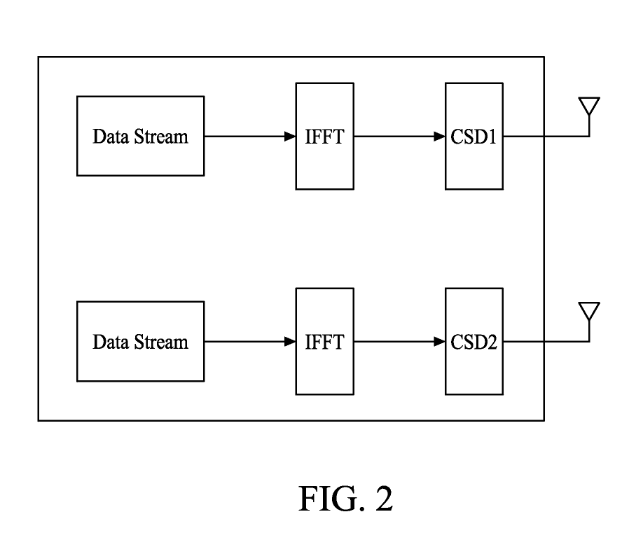

FIG. 3 shows another MIMO system using CSD technique;

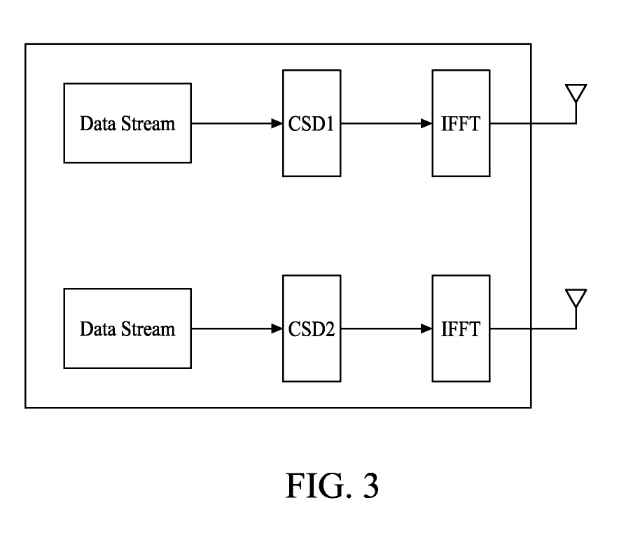

FIG. 4 shows a signal processing apparatus for a MIMO system according to an embodiment of the present invention;

FIG. 5 shows the flow chart of a signal processing method for a MIMO system according to an embodiment of the present invention;

FIG. 6 shows the phase rotation of a frequency domain MIMO data stream according to an embodiment of the present invention;

FIG. 7 shows a signal processing apparatus for a MIMO system according to another embodiment of the present invention;

FIG. 8 shows a signal processing apparatus for a MIMO system according to another embodiment of the present invention;

FIG. 9 shows a signal processing apparatus for a MIMO system according to another embodiment of the present invention;

FIG. 10 shows a signal processing apparatus for a MIMO system according to another embodiment of the present invention;

FIG. 11 shows the flow chart of a signal processing method for a MIMO system according to another embodiment of the present invention;

FIG. 12 shows a signal processing apparatus for a MIMO system according to another embodiment of the present invention;

FIG. 13 shows a signal processing apparatus for a MIMO system according to yet another embodiment of the present invention; and

FIG. 14 shows the flow chart of a signal processing method for a MIMO system according to yet another embodiment of the present invention.

### DETAILED DESCRIPTION OF THE INVENTION

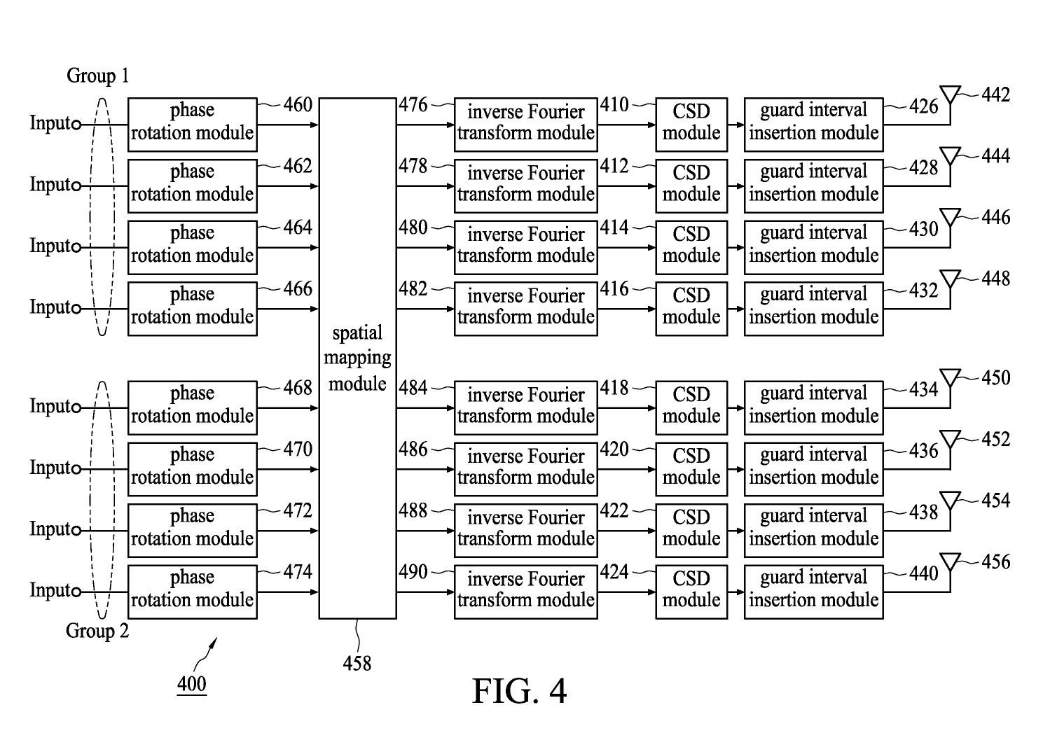

FIG. 4 shows a signal processing apparatus for a MIMO system according to an embodiment of the present invention. As shown in FIG. 4, the signal processing apparatus 400 comprises eight phase rotation modules 460 to 474, eight inverse Fourier transform modules 476 to 490, eight CSD modules 410 to 424, eight guard interval insertion modules 426 to 440, eight antennas 442 to 456 and a spatial mapping module 458. The phase rotation modules 460 to 474 are configured to rotate the phases of the sub-carriers of eight frequency domain MIMO data streams. The spatial mapping module 458 is configured to perform spatial mapping on the eight frequency domain MIMO data streams. The inverse Fourier transform modules 476 to 490 are configured to transform the eight frequency domain MIMO data streams into eight time domain MIMO data streams. The CSD modules 410 to 424 are configured to perform CSD for the eight time domain MIMO data streams. The guard interval insertion modules 426 to 440 are configured to insert guard intervals into the eight time domain MIMO data streams. The antennas 442 to 456 are configured to broadcast the eight time domain MIMO data streams.

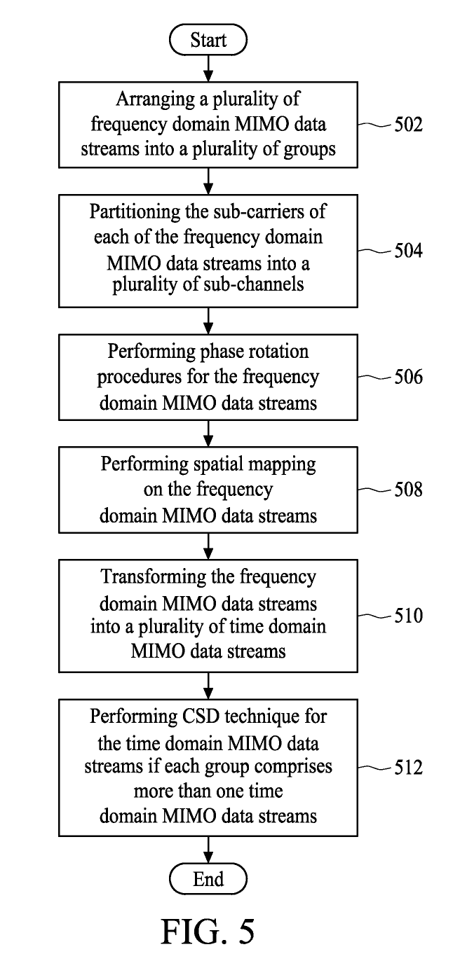

FIG. 5 shows the flow chart of a signal processing method for a MIMO system according to an embodiment of the present invention. In step 502, a plurality of frequency domain MIMO data streams are arranged into a plurality of groups, wherein each group comprises at least one frequency domain MIMO data stream, and then step 504 is executed. In step 504, the sub-carriers of each of the frequency domain MIMO data streams are partitioned into a plurality of sub-channels, and then step 506 is executed. In step 506, phase rotation procedures are performed for the frequency domain MIMO data streams, wherein the phases of the sub-carriers in one sub-channel are rotated the same amount, and different phase rotations are employed on different groups of the plurality of frequency domain MIMO data streams, and then step 508 is executed. In step 508, a spatial mapping procedure is performed on the plurality of frequency domain MIMO data streams, and then step 510 is executed. In step 510, the frequency domain MIMO data streams are transformed into a plurality of time domain MIMO data streams, and then step 512 is executed. In step 512, the CSD technique is performed for the time domain MIMO data streams if each group comprises more than one time domain MIMO data stream, wherein the amount of the CSD is different for each time domain MIMO data stream in a group.

The following illustrates how to apply the signal processing method shown in FIG. 5 to the signal processing apparatus shown in FIG. 4. In a MIMO system compatible with the IEEE 802.11n standard, a plurality of frequency domain MIMO spatial streams are applied to the signal processing apparatus shown in FIG. 4. In this example, the frequency domain MIMO spatial streams comprise eight data streams, and the fundamental bandwidth of the MIMO system is 20 MHz, i.e., the fundamental sampling rate of the MIMO system is 50 ns. The MIMO system can be operated under a 20 MHz mode, a 40 MHz mode, an 80 MHz mode, or the mix of the three modes. In the 20 MHz mode, the MIMO data stream comprises 64 sub-carriers. In the 40 MHz mode, the MIMO data stream comprises 128 sub-carriers. In the 80 MHz mode, the MIMO data stream comprises 256 sub-carriers.

In step 502, the eight data streams are arranged into two groups. In this example, the maximum number of MIMO data streams in a group is four. In step 504, the sub-carriers of each of the frequency domain MIMO data streams are partitioned into a plurality of sub-channels, and in step 506, phase rotation procedures are performed for the frequency domain MIMO data streams. For the 80 MHz mode frequency domain MIMO data streams, the sub-carriers are partitioned into four sub-channels. For the 40 MHz mode frequency domain MIMO data streams, the sub-carriers are partitioned into two sub-channels. For the 20 MHz mode frequency domain MIMO data streams, the sub-carriers are not partitioned. After the partition, each sub-channel comprises 64 sub-carriers and exhibits a bandwidth of 20 MHz. A first phase rotation is then performed. The phase rotation module 402 transforms the four frequency domain MIMO data streams in the first group, while the phase rotation module 404 transforms the four frequency domain MIMO data streams in the second group, wherein the phases of the sub-carriers in each sub-channel are rotated the same amount, and different phase rotations are performed on different groups of the plurality of frequency domain MIMO data streams. For instance, for the 20 MHz mode frequency domain MIMO data streams, a phase shift of ω₁=0 can be applied; for the 40 MHz mode frequency domain MIMO data streams, a phase shifts of ω₁=0 and ω₂=0.5π can be applied; for the 80MHz mode frequency domain MIMO data streams, a set of phase shifts of ω₁, ω₂, ω₃ and ω₄ can be applied. The following table shows some alternatives for phase shifts for the 80 MHz mode frequency domain MIMO data streams:

| ω₁ | ω₂ | ω₃ | ω₄ |
|---|---|---|---|
| 0 | 0 | 0 | π |
| 0 | 0 | π | 0 |
| 0 | 0.5 π | 0 | 1.5 π |
| 0 | 0.5 π | π | 0.5 π |
| 0 | π | 0 | 0 |
| 0 | π | π | π |
| 0 | 1.5 π | 0 | 0.5 π |
| 0 | 1.5 π | π | 1.5 π |

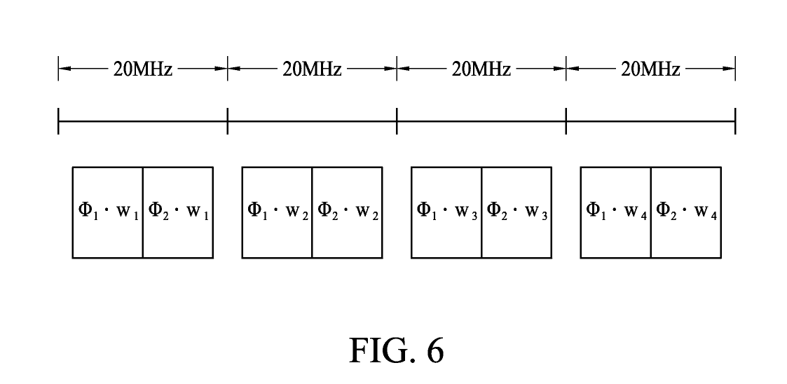

Accordingly, the phase rotation modules 460 to 466 can perform phase rotation for the frequency domain MIMO data streams in the first group with one set of phase shift in the above table, and the phase rotation modules 468 to 474 can perform phase rotation for the frequency domain MIMO data streams in the second group with another set of phase shift in the above table. For 80 MHz mode frequency domain MIMO data streams, the first phase rotation is sufficient to overcome the unintentional beam forming effect and a peak to average power ratio (PAPR) problem as well. However, for mix mode, i.e. 20 MHz/40 MHz/80 MHz mode, the first phase rotation is mainly to overcome the PAPR problem. Accordingly, a second first phase rotation can be performed to overcome the unintentional beam forming effect. Accordingly, the sub-carriers in each sub-channel can be further partitioned into N parts, and phases of the sub-carriers in each part are rotated by Φₖ, wherein k=1, 2 . . . , N. Each MIMO data stream in a group corresponds to a distinct set of Φ₁, Φ₂, . . . , Φ_{N}. In this example, the sub-carriers in each sub-channel are further partitioned into two parts. Accordingly, the phase shift set of the first group can be Φ₁=0 and Φ₂=0, and the phase shift set of the second group can be Φ₁=0.5π and Φ₂=0. FIG. 6 shows the phase rotation of the first frequency domain MIMO data stream.

In step 508, the spatial mapping module 458 performs spatial mapping procedure on the plurality of frequency domain MIMO data streams. In step 510, the inverse Fourier transform modules 476 to 482 transforms the frequency domain MIMO data streams in the first group into four time domain MIMO data streams. The inverse Fourier transform modules 484 to 490 transforms the frequency domain MIMO data streams in the second group into another set of four time domain MIMO data streams. In step 510, the CSD modules 410 to 416 perform CSD for the time domain MIMO data streams in the first group, and the CSD modules 418 to 424 perform CSD for the time domain MIMO data streams in the second group. The following table shows some alternatives for CSD values:

| Number of MIMO | CSD for | CSD for | CSD for | CSD for |
|---|---|---|---|---|
| data streams | the first | the second | the third | the fourth |
| in a group | data stream | data stream | data stream | data stream |
| 1 | 0 | | | |
| 2 | 0 | −200 ns | | |
| 3 | 0 | −100 ns | −200 ns | |
| 4 | 0 | −50 ns | −100 ns | −150 ns |

It should be noted that the amount of the CSD is different for each time domain MIMO data stream in a group. In some embodiments of the present invention, each group comprises only one time domain MIMO data stream. For such embodiments, step 512 is omitted. Next, the guard interval insertion modules 426 to 432 insert guard intervals into the time domain MIMO data stream in the first group, and the guard interval insertion modules 434 to 440 insert guard intervals into the time domain MIMO data stream in the second group. The antennas 442 to 456 then broadcast the eight time domain MIMO data streams.

It should be noted that the number of components of the signal processing apparatus provided by the present invention can be different from that of the signal processing apparatus shown in FIG. 4. For instance, the phase rotation modules 460 to 474 can be combined into a single phase rotation module, and the signal processing method shown in FIG. 5 can still be applied.

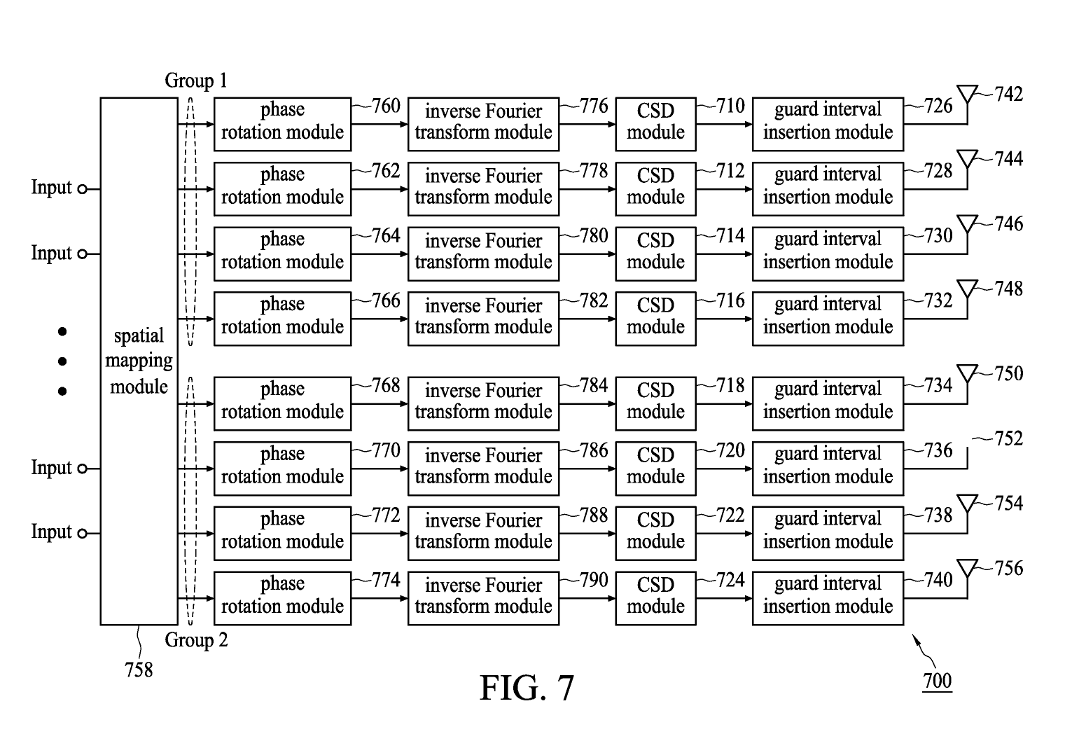

FIG. 7 shows a signal processing apparatus for a MIMO system according to another embodiment of the present invention. As shown in FIG. 7, the signal processing apparatus 700 comprises eight phase rotation modules 760 to 774, eight inverse Fourier transform modules 776 and 790, eight CSD modules 710 to 724, eight guard interval insertion modules 726 to 740, eight antennas 742 to 756 and a spatial mapping module 758. The spatial mapping module 758 is configured to perform spatial mapping on a plurality of frequency domain MIMO data streams and produce eight frequency domain MIMO data streams. The phase rotation modules 760 to 774 are configured to rotate the phases of the sub-carriers of the eight frequency domain MIMO data streams. The inverse Fourier transform modules 776 and 790 are configured to transform the eight frequency domain MIMO data streams into eight time domain MIMO data streams. The CSD modules 710 to 724 are configured to perform CSD for the eight time domain MIMO data streams. The guard interval insertion modules 726 to 740 are configured to insert guard intervals into the eight time domain MIMO data streams. The antennas 742 to 456 are configured to broadcast the eight time domain MIMO data streams.

As shown in FIG. 7, the signal processing apparatus 700 is similar to the signal processing apparatus 400 shown in FIG. 4 except that the spatial mapping procedure is performed before the phase rotation procedure. Correspondingly, a signal processing method for a MIMO system according to another embodiment of the present invention is similar to the signal processing method shown in FIG. 5 except that the order of steps 506 and 508 is reversed.

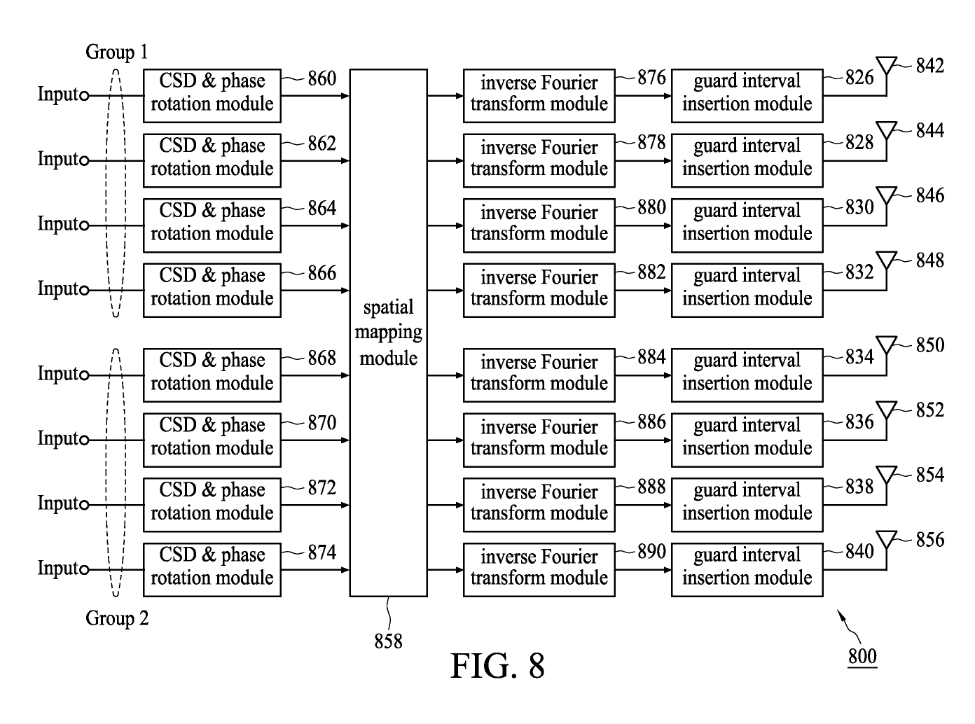

In some embodiments of the present invention, the cyclic shift delay is performed in the frequency domain. FIG. 8 shows a signal processing apparatus for a MIMO system according to one of such embodiments of the present invention. As shown in FIG. 8, the signal processing apparatus 800 comprises eight phase rotation and CSD modules 860 to 874, eight inverse Fourier transform modules 876 to 890, eight antennas 842 to 856 and a spatial mapping module 858. The phase rotation and CSD modules 860 to 874 are configured to rotate the phases of the sub-carriers of eight frequency domain MIMO data streams and perform CSD for the eight frequency domain MIMO data streams. The spatial mapping module 858 is configured to perform spatial mapping on the eight frequency domain MIMO data streams. The inverse Fourier transform modules 876 to 890 are configured to transform the eight frequency domain MIMO data streams into eight time domain MIMO data streams. The guard interval insertion modules 826 to 840 are configured to insert guard intervals into the eight time domain MIMO data streams. The antennas 842 to 856 are configured to broadcast the eight time domain MIMO data streams.

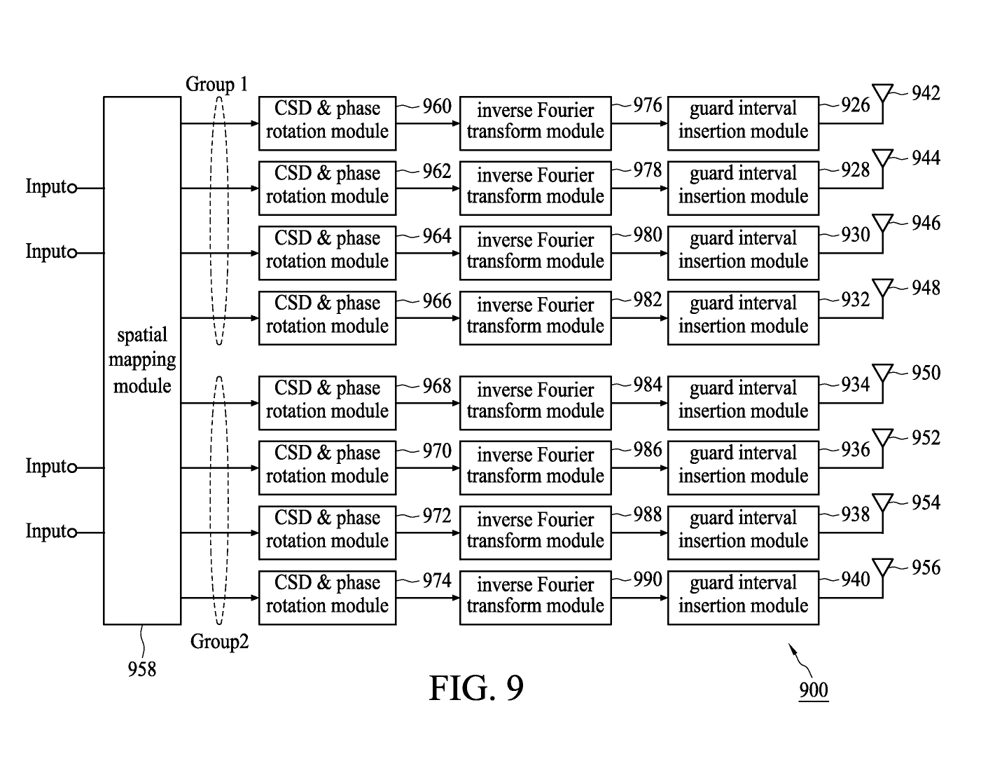

FIG. 9 shows a signal pressing apparatus for a MIMO system according to another embodiment of the present invention. As shown in FIG. 9, the signal processing apparatus 900 comprises eight phase rotation and CSD modules 960 to 974, eight inverse Fourier transform modules 976 to 990, eight antennas 942 to 956 and a spatial mapping module 958. The spatial mapping module 958 is configured to perform spatial mapping on a plurality of frequency domain MIMO data streams and produce eight frequency domain MIMO data streams. The phase rotation and CSD modules 860 to 874 are configured to rotate the phases of the sub-carriers of the eight frequency domain MIMO data streams and perform CSD for the eight frequency domain MIMO data streams. The inverse Fourier transform modules 876 to 890 are configured to transform the eight frequency domain MIMO data streams into eight time domain MIMO data streams. The guard interval insertion modules 826 to 840 are configured to insert guard intervals into the eight time domain MIMO data streams. The antennas 842 to 856 are configured to broadcast the eight time domain MIMO data streams.

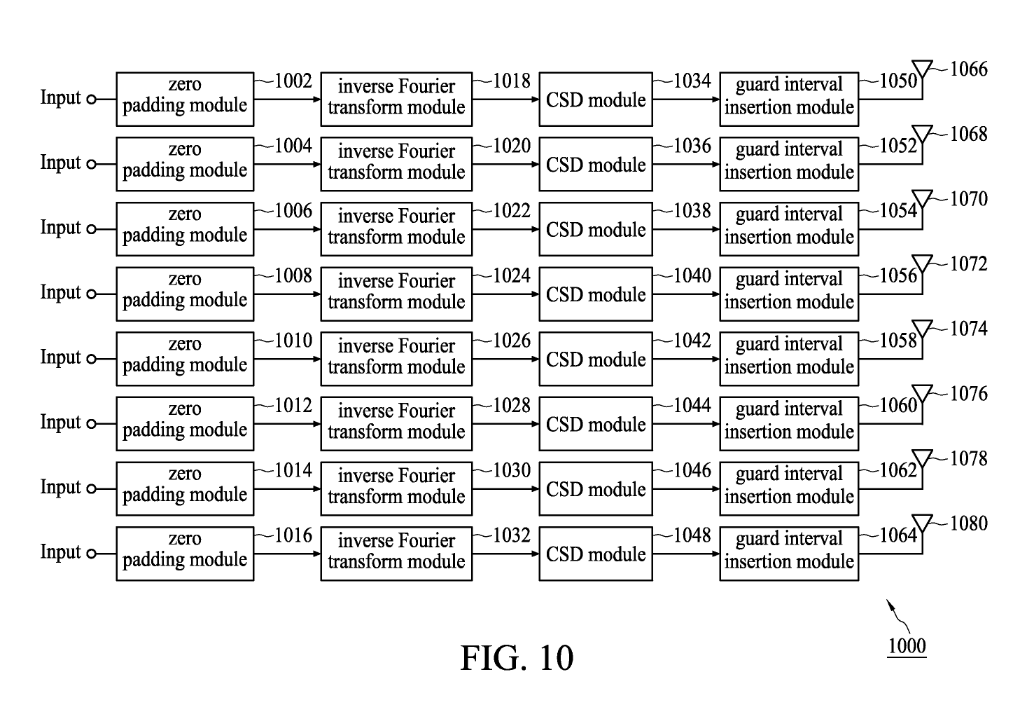

As shown in FIG. 9, the signal processing apparatus 900 is similar to the signal processing apparatus 800 shown in FIG. 8 except that the spatial mapping procedure is performed before the phase rotation and CSD procedure. Correspondingly, another two signal processing methods for a MIMO system according to some embodiments of the present invention are similar to the signal processing method shown in FIG. 5 except that the order of steps are rearranged. It can be seen from FIGS. 4, 7, 8 and 9 that the number of frequency domain MIMO data stream does not necessary equal to the number of streams after the spatial mapping procedure. However, the number of streams after the spatial mapping procedure equals to the number of time domain MIMO data stream. FIG. 10 shows a signal processing apparatus for a MIMO system according to another embodiment of the present invention. As shown in FIG. 10, the signal processing apparatus 1000 comprises eight zero padding modules 1002 to 1016, eight inverse Fourier transform modules 1018 to 1032, eight CSD modules 1034 to 1048, eight guard interval insertion modules 1050 to 1064 and eight antennas 1066 to 1080. The zero padding modules 1002 to 1016 are configured to extend eight frequency domain MIMO data streams by padding zeroes at the beginning and the end of each frequency domain MIMO data stream. The inverse Fourier transform modules 1018 to 1032 are configured to transform the eight frequency domain MIMO data streams into eight time domain MIMO data streams. The CSD modules 1034 to 1048 are configured to perform CSD for the eight time domain MIMO data streams. The guard interval insertion modules 1050 to 1064 are configured to insert guard intervals into the eight time domain MIMO data streams. The antennas 1066 to 1080 are configured to broadcast the eight time domain MIMO data streams.

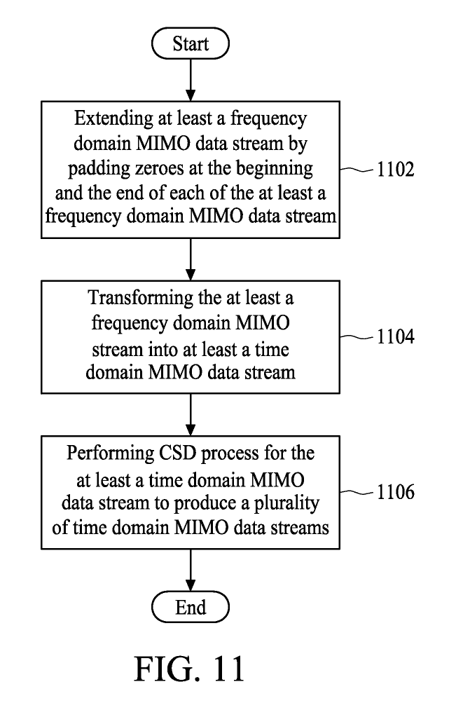

FIG. 11 shows the flow chart of a signal processing method for a MIMO system according to another embodiment of the present invention. In step 1102, at least one frequency domain MIMO data stream is extended by padding zeroes at the beginning and the end of each of the at least one frequency domain MIMO data stream, and step 1104 is executed. In step 1104, the at least one frequency domain MIMO stream is transformed into at least one time domain MIMO data stream, and step 806 is executed. In step 1106, CSD process is performed for the at least one time domain MIMO data stream to produce a plurality of time domain MIMO data streams, wherein the amount of CSD is different for each of the time domain MIMO data streams.

The following illustrates how to apply the signal processing method shown in FIG. 11 to the signal processing apparatus shown in FIG. 10. In a MIMO system compatible with the IEEE 802.11n standard, a plurality of frequency domain MIMO spatial streams are applied to the signal processing apparatus shown in FIG. 10. In this example, the frequency domain MIMO spatial streams comprise eight data streams. The frequency domain MIMO data streams can be categorized into three types: the 20 MHz type frequency domain MIMO data stream, which comprises 64 sub-carriers; the 40 MHz type frequency domain MIMO data stream, which comprises 128 sub-carriers; and the 80 MHz type frequency domain MIMO data stream, which comprises 256 sub-carriers. In this example, the eight frequency domain MIMO data streams are 20 MHz type frequency domain MIMO data streams.

In step 1102, the eight zero padding modules 1002 to 1016 extend the eight frequency domain MIMO data streams by padding zeroes at the beginning and the end of each frequency domain MIMO data stream. In this embodiment, a total of 192 zeroes are padded to each of the frequency domain MIMO data stream, wherein half of them are padded at the beginning of the respective data streams, and the other half are padded at the end of the respective data streams. Accordingly, each frequency domain MIMO data stream is extended so as to have 256 subcarriers. In step 1104, the inverse Fourier transform modules 1018 to 1032 transform the eight frequency domain MIMO data streams into eight time domain MIMO data streams respectively by performing 256-point inverse fast Fourier transform (IFFT) computations. In step 1106, the CSD modules 1034 to 1048 perform CSD process for the eight time domain MIMO data streams, respectively. The following table shows some alternatives of CSD values:

| Number | | | | | | | | | | | |
|---|---|---|---|---|---|---|---|---|---|---|---|
| of MIMO | | | | | | | | | | | |
| data | | | | | | | | | | | |
| streams | CSD1 | CSD2 | | CSD3 | | CSD4 | | CSD5 | CSD6 | CSD7 | CSD8 |
| 1 | 0 | | | | | | | | | | |
| 2 | 0 | −200 | ns | | | | | | | | |
| 3 | 0 | −100 | ns | −200 | ns | | | | | | |
| 4 | 0 | −50 | ns | −100 | ns | −200 | ns | | | | |
| 5 | 0 | −50 | ns | −100 | ns | −150 | ns | −200 ns | | | |
| 6 | 0 | −25 | ns | −50 | ns | −100 | ns | −150 ns | −200 ns | | |
| 7 | 0 | −25 | ns | −50 | ns | −100 | ns | −125 ns | −150 ns | −200 ns | |
| 8 | 0 | −25 | ns | −50 | ns | −75 | ns | −100 ns | −125 ns | −150 ns | −200 ns |

As shown in the above table, the minimum difference of the CSD is 25 ns. Since there are eight MIMO data streams, the last set of CSD is used. However, in some embodiments of the present invention, the number of MIMO data streams to be processed is not eight. In these embodiments, other sets of CSD in the above table may be used. Subsequently, the guard interval insertion modules 1050 to 1064 insert guard intervals into the eight time domain MIMO data streams, respectively. The antennas 1066 to 1080 then broadcast the eight time domain MIMO data streams.

It should be noted that in this embodiment, by extending the eight 20 MHz type frequency domain MIMO data streams to have 256 sub-carriers, the bandwidths of these frequency domain MIMO data streams, i.e. 80 MHz, are effectively increased. Accordingly, a CSD process with smaller minimum difference, such as the sampling rate of the MIMO system, 12.5 ns, can be performed.

It should be noted that the number of components of the signal processing apparatus provided by the present invention can be different from that of the signal processing apparatus shown in FIG. 10. For instance, the zero padding modules 1002 to 1016 can be combined into a single zero padding module, and the signal processing method shown in FIG. 11 can still be applied.

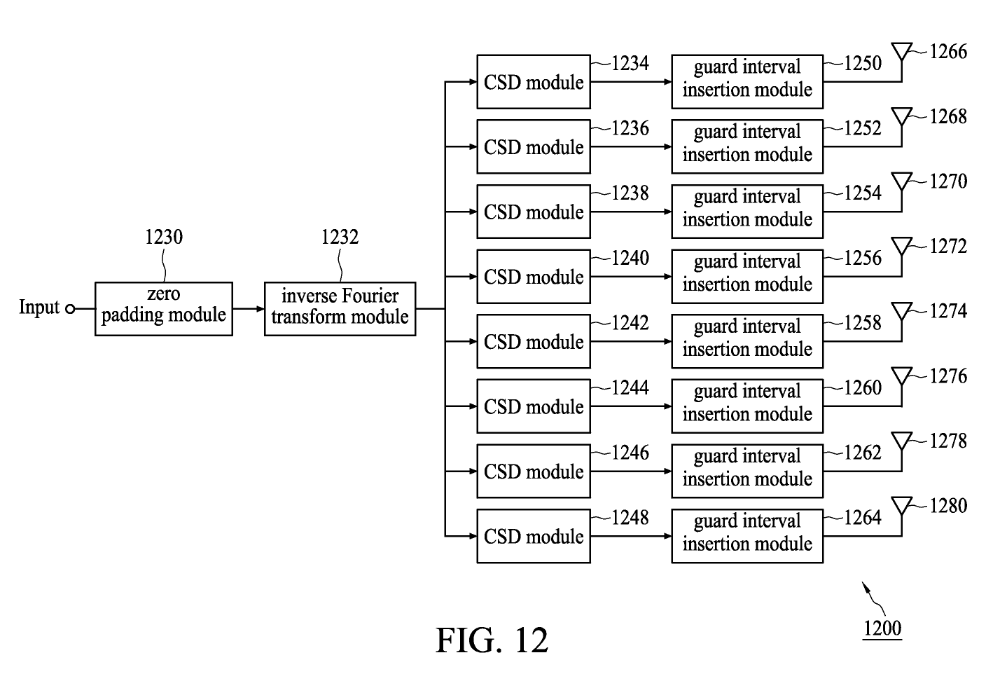

In order to be compatible with the IEEE 802.11n standard, in some embodiments of the present invention, only one frequency domain MIMO data stream needs to be processed. FIG. 12 shows a signal processing apparatus for a MIMO system according to yet another embodiment of the present invention. As shown in FIG. 12, the signal processing apparatus 1200 comprises a zero padding modules 1202, an inverse Fourier transform modules 1204, eight CSD modules 1234 to 1248, eight guard interval insertion modules 1250 to 1264 and eight antennas 1266 to 1280. The padding module 1202 is configured to a frequency domain MIMO data streams by padding zeroes at the beginning and the end of the frequency domain MIMO data stream. The inverse Fourier transform module 1204 is configured to transform the frequency domain MIMO data stream into a time domain MIMO data streams. The CSD modules 1234 to 1248 are configured to perform CSD for the time domain MIMO data stream with different cyclic shifts. The guard interval insertion modules 1250 to 1264 are configured to insert guard intervals into the eight time domain MIMO data streams. The antennas 1266 to 1280 are configured to broadcast the eight time domain MIMO data streams. In this embodiment, the frequency domain MIMO data stream is padded with zeroes, transformed into a time domain data stream, and then duplicated into a plurality of time domain MIMO data streams. Next, the CSD process can be performed on the plurality of time domain MIMO data streams, wherein the amount of the CSD is different for each of the time domain MIMO spatial streams.

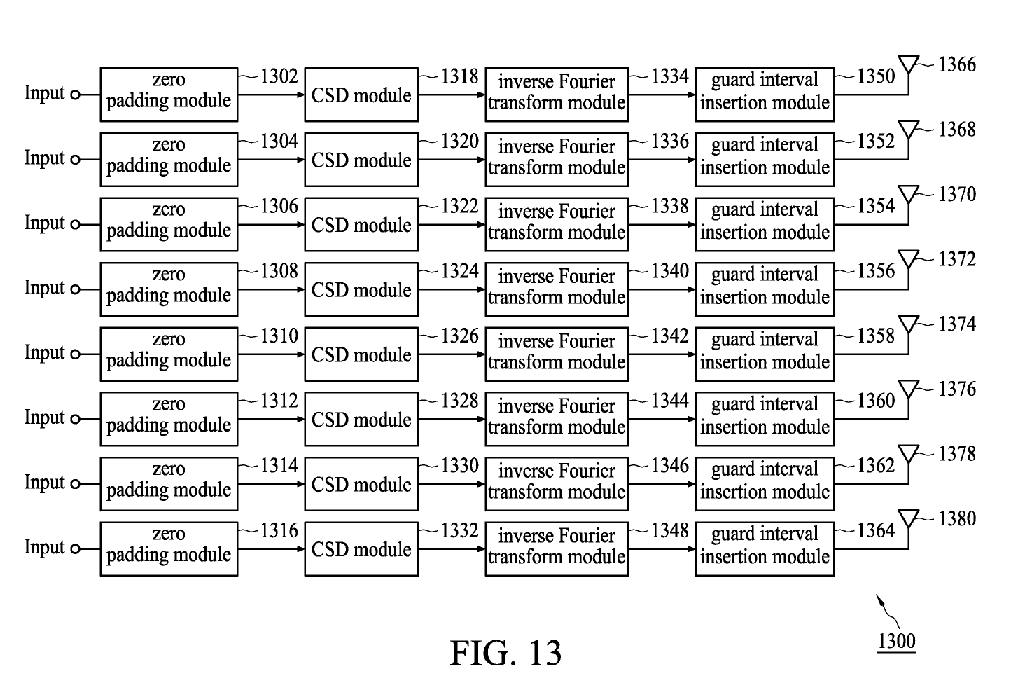

FIG. 13 shows a signal processing apparatus for a MIMO system according to yet another embodiment of the present invention. As shown in FIG. 13, the signal processing apparatus 1300 comprises eight zero padding modules 1302 to 1316, eight CSD modules 1318 to 1332, eight inverse Fourier transform modules 1334 to 1348, eight guard interval insertion modules 1350 to 1364 and eight antennas 1366 to 1380. The zero padding modules 1302 to 1316 are configured to extend eight frequency domain MIMO data streams by padding zeroes at the beginning and the end of each frequency domain MIMO data stream. The CSD modules 1318 to 1332 are configured to perform CSD for the eight frequency domain MIMO data streams. The inverse Fourier transform modules 1334 to 1348 are configured to transform the eight frequency domain MIMO data streams into eight time domain MIMO data streams. The guard interval insertion modules 1350 to 1364 are configured to insert guard intervals into the eight time domain MIMO data streams. The antennas 1366 to 1380 are configured to broadcast the eight time domain MIMO data streams.

It can be seen from FIG. 13 that the architecture of the signal processing apparatus 1300 is similar to that of the signal processing apparatus 1000, except that the CSD procedure is performed in frequency domain in the signal processing apparatus 1000. Accordingly, the CSD procedure in frequency domain is mainly to rotate the phases of the sub-carriers of the frequency domain MIMO data streams. In this embodiment, however, the CSD modules 1318 to 1332 are required only when better resolutions of the MIMO data streams are preferred.

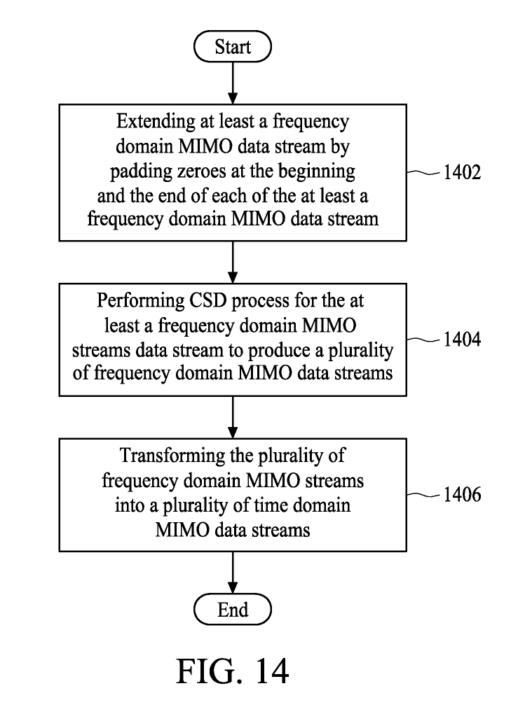

FIG. 14 shows the flow chart of a signal processing method for a MIMO system according to yet another embodiment of the present invention. In step 1402, at least one frequency domain MIMO data stream is extended by padding zeroes at the beginning and the end of each of the at least one frequency domain MIMO data stream, and step 804 is executed. In step 1404, CSD process is performed for the at least one frequency domain MIMO data stream to produce a plurality of frequency domain MIMO data streams, and step 1406 is executed, wherein the amount of phase rotation is different for each of the frequency domain MIMO data streams. In step 1406, the plurality of frequency domain MIMO streams are transformed into a plurality of time domain MIMO data streams.

It can be seen from FIG. 14 that the signal processing method is similar to the signal processing method shown in FIG. 12 except that the CSD procedure is performed in frequency domain. Accordingly, the CSD procedure in frequency domain is mainly to rotate the phases of the sub-carriers of the frequency domain MIMO data streams. Likewise, the zero padding procedure in step 1402 is performed only when better resolutions of the MIMO data streams are preferred.

In conclusion, the signal processing method and apparatus for a MIMO system of the present invention provide a unique solution when the number of applied antennas increases or the transmission bandwidth is extended. By processing the MIMO data streams to be transmitted in the frequency domain, the objective of the present invention is achieved.

The above-described embodiments of the present invention are intended to be illustrative only. Those skilled in the art may devise numerous alternative embodiments without departing from the scope of the following claims.

What is claimed is:

1. A signal processing method for a multiple-input-multiple-output (MIMO) system, comprising the steps of:
arranging a plurality of frequency domain MIMO data streams into a plurality of groups, wherein each group comprises at least one frequency domain MIMO data stream;
partitioning sub-carriers of each of the plurality of frequency domain MIMO data streams into a plurality of sub-channels;
performing phase rotation on the plurality of frequency domain MIMO data streams, wherein the phases of the sub-carriers in a sub-channel are rotated with the same amount, and different phase rotations are performed on different groups of the plurality of frequency domain MIMO data streams;
transforming the plurality of frequency domain MIMO data streams into a plurality of time domain MIMO data streams; and
performing cyclic shift delay for the plurality of time domain MIMO data streams if each group comprises more than one time domain MIMO data streams, wherein the amount of the cyclic shift delay is different for each time domain MIMO data stream in a group.

2. The signal processing method of claim 1, wherein the bandwidth of each of the sub-channels is equal to a fundamental bandwidth of the MIMO system.

3. The signal processing method of claim 1, wherein the bandwidth of each of the sub-channels is equal to 1/N of the fundamental bandwidth of the MIMO system, and N is an integer greater than one.

4. The signal processing method of claim 3, wherein the phase rotation step is performed by combining phase rotation for each sub-channel such that the phase rotation performed on the k^{th} sub-channel is equal to that performed on the (k+N)^{th} and the phase rotation for each N sub-channels with the same amount.

5. The signal processing method of claim 1, wherein the minimum phase difference of the phase rotations is 90 degrees.

6. The signal processing method of claim 1, wherein the minimum difference of the cyclic shift delays is equal to a fundamental sampling rate of the MIMO system.

7. The signal processing method of claim 1, further comprising the step of:
performing spatial mapping on the frequency domain MIMO data streams.

8. The signal processing method of claim 7, wherein the step of phase rotation is performed after the step of spatial mapping.

9. The signal processing method of claim 7, wherein the step of phase rotation is performed before the step of spatial mapping.

10. A signal processing method for a multiple-input-multiple-output (MIMO) system, comprising the steps of:
arranging a plurality of frequency domain MIMO data streams into a plurality of groups, wherein each group comprises at least one frequency domain MIMO data stream;
partitioning sub-carriers of each of the plurality of frequency domain MIMO data streams into a plurality of sub-channels;
performing phase rotation on the plurality of frequency domain MIMO data streams, wherein the phases of the sub-carriers in a sub-channel are rotated with the same amount, and different phase rotations are performed on different groups of the plurality of frequency domain MIMO data streams;
performing cyclic shift delay on the plurality of frequency domain MIMO data streams if each group comprises more than one frequency domain MIMO data streams, wherein the amount of the cyclic shift delay is different for each frequency domain MIMO data stream in a group; and
transforming the plurality of frequency domain MIMO data streams into a plurality of time domain MIMO data streams.

11. The signal processing method of claim 10, wherein the bandwidth of each of the sub-channels is equal to a fundamental bandwidth of the MIMO system.

12. The signal processing method of claim 10, wherein the bandwidth of each of the sub-channels is equal to 1/N of the fundamental bandwidth of the MIMO system, and N is an integer greater than one.

13. The signal processing method of claim 12, wherein the phase rotation step is performed by combining phase rotation for each sub-channel such that the phase rotation performed on the k^{th} sub-channel is equal to that performed on the (k+N)^{th} and the phase rotation for each N sub-channels with the same amount.

14. The signal processing method of claim 10, wherein the minimum phase difference of the phase rotations is 90 degrees.

15. The signal processing method of claim 10, wherein the minimum difference of the cyclic shift delays is equal to a fundamental sampling rate of the MIMO system.

16. The signal processing method of claim 10, further comprising the step of:
performing spatial mapping on the frequency domain MIMO data streams.

17. The signal processing method of claim 16, wherein both the steps of phase rotation and cyclic shift delay are performed after the step of spatial mapping.

18. The signal processing method of claim 16, wherein both the steps of phase rotation and cyclic shift delay are performed before the step of spatial mapping.

19. A signal processing method for a multiple-input-multiple-output (MIMO) system, comprising the steps of:
extending at least one frequency domain MIMO data stream by padding zeroes at the beginning and at the end of each of the at least one frequency domain MIMO data stream;
transforming the at least one frequency domain MIMO stream into at least one time domain MIMO data stream; and
performing cyclic shift delay for the at least one time domain MIMO data stream to produce a plurality of time domain MIMO data streams, wherein the amount of the cyclic shift delay is different for each of the time domain MIMO data streams.

20. The signal processing method of claim 19, wherein the minimum difference of the cyclic shift delays is a sampling rate of the MIMO system.

21. The signal processing method of claim 19, wherein for each of the frequency domain MIMO data streams, the number of padded zeroes at the beginning of the data stream is the same as the number of padded zeroes at the end of the data stream.

22. The signal processing method of claim 19, wherein the number of sub-carriers in each of the frequency domain MIMO data streams before being extended is 64.

23. The signal processing method of claim 19, wherein the number of sub-carriers in each of the extended frequency domain MIMO data streams is 256.

24. A signal processing apparatus for a multiple-input-multiple-output (MIMO) system, comprising:
a phase rotation module configured to rotate the phases of the sub-carriers of a frequency domain MIMO data stream, wherein the sub-carriers of the frequency domain MIMO data stream are partitioned into a plurality of sub-channels, and the phases of the sub-carriers in a sub-channel are rotated the same amount;
an inverse Fourier transform module configured to transform the frequency domain MIMO data stream into a time domain MIMO data stream; and
a cyclic shift delay module configured to perform cyclic shift delay for the time domain MIMO data stream.

25. The signal processing apparatus of claim 24, wherein the bandwidth of each of the sub-channels is equal to a fundamental bandwidth of the MIMO system.

26. The signal processing apparatus of claim 24, wherein the bandwidth of each of the sub-channels is equal to 1/N of the fundamental bandwidth of the MIMO system, and N is an integer greater than one.

27. The signal processing apparatus of claim 24, wherein the minimum phase difference of the phase rotations is 90 degrees.

28. The signal processing apparatus of claim 25, wherein the minimum difference of the cyclic shift delays is equal to the fundamental sampling rate of the MIMO system.

29. The signal processing apparatus of claim 24, which further comprises eight antennas.

30. The signal processing apparatus of claim 24, further comprising:
a spatial mapping module configured to perform spatial mapping on the frequency domain MIMO data stream.

31. The signal processing apparatus of claim 30, wherein the spatial mapping module is configured to perform spatial mapping on the frequency domain MIMO data stream outputted by the phase rotation module.

32. The signal processing apparatus of claim 30, wherein the phase rotation module is configured to perform phase rotation on the frequency domain MIMO data stream outputted by the spatial mapping module.

33. A signal processing apparatus for a multiple-input-multiple-output (MIMO) system, comprising:
a phase rotation and cyclic shift delay module configured to rotate the phases of the sub-carriers of a frequency domain MIMO data stream and perform cyclic shift delay for the frequency domain MIMO data stream, wherein the sub-carriers of the frequency domain MIMO data stream are partitioned into a plurality of sub-channels, and the phases of the sub-carriers in a sub-channel are rotated the same amount; and
an inverse Fourier transform module configured to transform the frequency domain MIMO data stream into a time domain MIMO data stream.

34. The signal processing apparatus of claim 33, wherein the bandwidth of each of the sub-channels is equal to a fundamental bandwidth of the MIMO system.

35. The signal processing apparatus of claim 33, wherein the bandwidth of each of the sub-channels is equal to 1/N of the fundamental bandwidth of the MIMO system, and N is an integer greater than one.

36. The signal processing apparatus of claim 33, wherein the minimum phase difference of the phase rotations is 90 degrees.

37. The signal processing apparatus of claim 34, wherein the minimum difference of the cyclic shift delays is equal to the fundamental sampling rate of the MIMO system.

38. The signal processing apparatus of claim 33, which further comprises eight antennas.

39. The signal processing apparatus of claim 33, further comprising:
a spatial mapping module configured to perform spatial mapping on the frequency domain MIMO data stream.

40. The signal processing apparatus of claim 39, wherein the spatial mapping module is configured to perform spatial mapping on the frequency domain MIMO data stream outputted by the phase rotation and cyclic shift delay module.

41. The signal processing apparatus of claim 39, wherein the phase rotation and cyclic shift delay module is configured to perform phase rotation and cyclic shift delay on the frequency domain MIMO data stream outputted by the spatial mapping module.

42. A signal processing apparatus for a multiple-input-multiple-output (MIMO) system, comprising:
a zero padding module configured to extend a frequency domain MIMO data stream by padding zeroes at the beginning and at the end of the frequency domain MIMO data stream;
an inverse Fourier transform module configured to transform the frequency domain MIMO data stream into a time domain MIMO data stream; and
a cyclic shift delay module configured to perform cyclic shift delay for the time domain MIMO data stream.

43. The signal processing apparatus of claim 42, wherein the minimum difference of the cyclic shift delays is a sampling rate of the MIMO system.

44. The signal processing apparatus of claim 42, wherein the number of padded zeroes at the beginning of the frequency domain MIMO data stream is the same as the number of padded zeroes at the end of the frequency domain MIMO data stream.

45. The signal processing apparatus of claim 42, wherein the number of sub-carriers in each of the frequency domain MIMO data streams before being extended is 64.

46. The signal processing apparatus of claim 42, wherein the number of sub-carriers in each of the extended frequency domain MIMO data stream is 256.

47. The signal processing apparatus of claim 42, which further comprises eight antennas.

48. A signal processing method for a multiple-input-multiple-output (MIMO) system, comprising the steps of:
performing cyclic shift delay for at least one frequency domain MIMO data stream to produce a plurality of frequency domain MIMO data streams, wherein the amount of the cyclic shift delay is different for each of the frequency domain MIMO data streams; and
transforming the plurality of frequency domain MIMO stream into a plurality of time domain MIMO data stream.

49. The signal processing method of claim 48, which further comprises the step of:
extending the at least one frequency domain MIMO data stream by padding zeroes at the beginning and at the end of each of the at least one frequency domain MIMO data stream before performing cyclic shift delay.

50. The signal processing method of claim 48, wherein the minimum difference of the cyclic shift delays is a sampling rate of the MIMO system.

51. The signal processing method of claim 49, wherein for each of the frequency domain MIMO data streams, the number of padded zeroes at the beginning of the data stream is the same as the number of padded zeroes at the end of the data stream.

52. The signal processing method of claim 49, wherein the number of sub-carriers in each of the frequency domain MIMO data streams before being extended is 64.

53. The signal processing method of claim 49, wherein the number of sub-carriers in each of the extended frequency domain MIMO data streams is 256.

54. A signal processing apparatus for a multiple-input-multiple-output (MIMO) system, comprising:
a cyclic shift delay module configured to perform cyclic shift delay for a frequency domain MIMO, data stream; and
an inverse Fourier transform module configured to transform the frequency domain MIMO data stream into a time domain MIMO data stream.

55. The signal processing apparatus of claim 54, which further comprises:
a zero padding module configured to extend the frequency domain MIMO data stream by padding zeroes at the beginning and at the end of the frequency domain MIMO data stream.

56. The signal processing apparatus of claim 55, wherein the minimum difference of the cyclic shift delays is a sampling rate of the MIMO system.

57. The signal processing apparatus of claim 55, wherein the number of padded zeroes at the beginning of the frequency domain MIMO data stream is the same as the number of padded zeroes at the end of the frequency domain MIMO data stream.

58. The signal processing apparatus of claim 55, wherein the number of sub-carriers in each of the frequency domain MIMO data streams before being extended is 64.

59. The signal processing apparatus of claim 55, wherein the number of sub-carriers in each of the extended frequency domain MIMO data stream is 256.

60. The signal processing apparatus of claim 54, which further comprises eight antennas.
